(19) United States
(12) Patent Application Publication
(10) Pub. No.: US 2011/0006007 A1
(43) Pub. Date: Jan. 13, 2011

(54) COMPOSITE POLYMERIC FILTRATION MEDIA

(76) Inventors: Gokhan Kuruc, Meriden, CT (US); Marjorie Bucholz, Meriden, CT (US); Todd E. Arnold, Glastonbury, CT (US); Robert T. Fitzsimons, JR., Minneapolis, MN (US); Kannan Seshadri, Woodbury, MN (US); Steven M. Heilmann, Afton, MN (US); Andrew W. Rabins, St. Paul, MN (US); Catherine A. Bothof, Stillwater, MN (US)

Correspondence Address: 3M INNOVATIVE PROPERTIES COMPANY, PO BOX 33427, ST. PAUL, MN, 55133-3427, US

(21) Appl. No.: 12/746,961

(22) PCT Filed: Dec. 19, 2008
(86) PCT No.: PCT/US08/87590

§ 371 Date: Sep. 24, 2010

Related U.S. Application Data
(60) Provisional application No. 61/027,990, filed on Feb. 12, 2008.

(51) Int. Cl. B01D 15/08; B01J 20/26; B01D 39/00; C02F 1/28; B01D 24/00; B01D 69/12

(52) U.S. Cl. 210/656; 502/402; 210/435; 210/679; 210/287; 210/321.6

(57) ABSTRACT

Provided are filtration media, matrixes, and systems for liquid purification that utilize functional polymer particles. The functional polymer particles can comprise a cationic charge. Exemplary functional polymer particles comprise comprise [3-(methacryloylamino)propyl]-trimethylammonium chloride (MAPTAC) polymerized with trimethylolpropane trimethacrylate (TMPTMA).

### TECHNICAL FIELD

The present disclosure relates to filter media and matrixes. More specifically, provided are filter matrixes formed from functional polymer particles in combination with polymeric binders for use in water filtration systems.

### BACKGROUND

Filtration of fluids may be accomplished through a variety of technologies, the selection of which is often determined by the contaminant(s) or particle(s) that are being targeted for removal, reduction, capture, or isolation.

Particulates are best removed through a process known as depth filtration. The filter collects and holds any dirt or sediment within the depth of its matrix. Dissolved organic contaminants appearing on a molecular level or other biological contaminants may be removed through adsorption or, in the case of minerals and metals, through ion exchange. Proteins can be removed via IEX or affinity chromatography. Metals are also likely to be removed via chelation. Very small contaminants, including microorganisms down to sub-micron sizes often require some form of membrane technology in which the pores in the membrane are configured to be smaller than the target contaminant; or they can be deactivated in some manner.

Traditionally, technologies used for depth filtration use diatomaceous earth, carbon, or other adsorbers and absorbers, along with cellulose and charge modifying resin materials to make a filtration matrix. These materials of construction, however, can be contaminated to varying degrees with trace metals, bioburden (bacteria, fungi, etc.), endotoxins, and beta-glucans. In the pharmaceutical industry, for example, the presence of such contaminants is problematic. For example, beta-glucans may be present and can result in false positives for endotoxins in Limulus Amebocyte Lysate (LAL) testing. To address shedding or flushing out of materials of composition, wet strength resins have been incorporated into filtration matrixes to impart tensile strength to cellulose-based media and to provide a net positive charge to the filtration matrix. In some cases, these resins require an activation step of, for example, adding additional chemistries, resins, buffers, solutions, or heat. The use of wet strength resins adds processing steps of flushing the media prior to use to reduce or eliminate residual, unbound resin and the sensitivity of the resin/cross-linking chemistry and reaction conditions used to bind the resin to the media matrix.

Further, naturally occurring diatomaceous earth may not have consistent quality for different batches. Moreover, the use of diatomaceous earth can lead to inefficiencies and use of extra resources because the traditional processes for activating diatomaceous earth typically use large volumes of water and for preparation of the filter requires die-cutting of the media sheets, leading to large amounts of unusable media.

With regard to capture and isolation of particles, packed bed chromatography columns are typically employed. In bind and elute chromatography, a desired species is adsorbed and then recovered by changing the pH and/or salt molarity. In flowthrough chromatography, contaminants such as DNA or host cell proteins (HCP's) are captured, while the product or protein of interest passes through the chromatography column. Chromatography use is prevalent in bioprocessing, where purification of a product is an expensive undertaking Untreated products typically have titers in the final fermentation broth at levels well below 1%. Typical chromatographic methods used in these processes include ion exchange, ligand adsorbants such as protein A, or hydrophobic interaction chromatography.

Packed bed chromatography, however, suffers from several limitations in a manufacturing environment. Pressure drop limitations restrict the bed depth to 20-30 cm. As batch sizes and product titers increase in fermentation, this requires that chromatography columns grow wider and wider to provide adequate capacity. Some columns have grown to 150-200 cm wide, which stretches the limits of packing such a large column and validating that flow distribution and packing density are uniform. Packed column chromatography also suffers from poor flux, difficulties in cleaning, and the need to protect the columns from particulates in the feedstream.

Alternatives to packed bed chromatography have been explored. Batch adsorption, where the chromatography particles are mixed with the feed in a stirred tank, is impractical, inefficient, and can cause particle breakage from the agitator impellers. Chromatography membranes are packaged in a conventional filter cartridge, and although can provide adequate flux and pressure drop characteristics, they suffer from limited binding capacity. This low capacity limits the use of current membrane chromatography products to applications such as final polishing purification, where very small amounts of contaminants are encountered.

There is an ongoing need to provide improved filtration media having increased capacity and reduced pressure drop. There also exists a need to provide improved filtration media while reducing waste associated with the manufacturing processes. There also exists a need with regard to depth filter media matrix such as blocks, pads, sheets and other formats, for a mechanism for reduction of phage, virus, or bacteria that is not dependent on the pore size or pore size distribution of the filter media matrix; especially where the filter media matrix pore characteristics cannot effectively reduce a large microorganism such as a cyst. It is also desirable to provide chromatography columns having improved flux, efficiency, and binding capacity.

### SUMMARY

Provided are filtration media, matrixes, and systems for liquid purification that utilize functional polymer particles. In one aspect, provided are filtration matrixes for the removal of contaminants comprising functional polymer particles and a polymeric binder. In an embodiment, the functional polymer particles comprise a cationic charge. In another embodiment, the functional polymer particles comprise an anionic charge. In a detailed embodiment, wherein the functional polymer particles comprise polymerized [3-(methacryloylamino)propyl]-trimethylammonium chloride (MAPTAC) and an amount of at least 15% by weight of the particles of a cross-linker. In another detailed embodiment, the functional polymer particles comprise [3-(methacryloylamino)propyl]-trimethylammonium chloride (MAPTAC) polymerized with trimethylolpropane trimethacrylate (TMPTMA). A further embodiment provides that a ratio of trimethylolpropane trimethacrylate (TMPTMA) to [3-(methacryloylamino)propyl]-trimethylammonium chloride (MAPTAC) is in the range of 95:5 to 15:85. One or more embodiments provide that the filtration matrix is effective to provide an increased charge capacity as compared to a comparative filtration matrix that does not contain any functional polymer particles.

In one or more embodiments, the filtration matrix is substantially free of naturally-occurring filter materials. These embodiments can provide that the functional polymer particles are present in an amount of at least 10% by weight of the matrix. On the other hand, certain embodiments of the filtration matrix comprise up to 40% by weight of a naturally-occurring filter material. In these embodiments, the filtration matrix can comprise up to about 5% by weight of the functional polymer and can be effective to provide a charge capacity that is at least a factor of 3 times greater than the comparative filtration matrix.

In further embodiments, the polymeric binder comprises polyethylene. Specific embodiments provide that the polyethylene comprises ultra high molecular weight polyethylene. Other embodiments include the polymeric binder comprising particles having an irregular, convoluted surface.

Another aspect provides filtration matrix comprising a precipitation polymer of [3-(methacryloylamino)propyl]-trimethylammonium chloride (MAPTAC) polymerized with trimethylolpropane trimethacrylate (TMPTMA) and a polymeric binder comprising particles having an irregular, convoluted surface. In one or more embodiments, the particles having an irregular, convoluted surface are formed from ultra high molecular weight polyethylene. Other embodiments provide that the polymeric binder further comprises particles of substantially spherical shape. In a detailed embodiment, a ratio of the particles having an irregular, convoluted surface to the particles of substantially spherical shape is in the range of 1:1 to 10:1. Another embodiment provides that a ratio of trimethylolpropane trimethacrylate (TMPTMA) to [3-(methacryloylamino)propyl]-trimethylammonium chloride (MAPTAC) is from 95:5 to 15:85. In another embodiment, the precipitation polymer is present in an amount in the range of 10 to 60% by weight and the polymeric binder is present in an amount in the range of 40 to 90% by weight.

In a further aspect, provided are filtration systems comprising filter matrix formed from functional polymer particles and a polymeric binder, a housing surrounding the filter matrix, a fluid inlet, and a fluid outlet. In a detailed embodiment, the functional polymer particles comprise [3-(methacryloylamino)propyl]-trimethylammonium chloride (MAPTAC) polymerized with trimethylolpropane trimethacrylate (TMPTMA). In one embodiment, the polymeric binder comprises ultra high molecular weight polyethylene particles having an irregular, convoluted surface. In another embodiment, the polymeric binder comprises a filter membrane formed from polyethylene glycol, and polyethersulfone.

Other aspects provide methods of filtering comprising contacting a fluid with a filtration matrix comprising functional polymer particles and a polymeric binder. One embodiment provides that the filtration matrix has a thickness in the range of 3 to 100 mm. In an embodiment, the method further comprises locating the filtration matrix in a depth filtration system. Other embodiments provide that the method further comprises locating the filtration matrix in a chromatography system. In another embodiment, the filtration matrix has an increased charge capacity as compared to a comparative filtration matrix that does not contain any functional polymer particles. Other embodiments provide that the filtration matrix has a capacity of at least 35 mg/ml of a biomolecule at 10% breakthrough.

Other aspects include methods of making a filtration system comprising: providing functional polymer particles; contacting a polymeric binder with the functional polymer particles to form a media mixture; heating the media mixture form a filtration matrix; and inserting the filtration block in a housing to form the filtration system. Certain methods further comprise adding one or more naturally-occurring materials to the media mixture. In one or more embodiments, the functional polymer particles are provided by preparing a precipitation polymer of [3-(methacryloylamino)propyl]-trimethylammonium chloride (MAPTAC) with at least 15% by weight of the particles of a cross-linker A detailed embodiment provides that the functional polymer particles are prepared from [3-(methacryloylamino)propyl]-trimethylammonium chloride (MAPTAC) polymerized with trimethylolpropane trimethacrylate (TMPTMA) in a ratio in the range of 95:5 to 15:85 of TMPTMA to MAPTAC.

### DETAILED DESCRIPTION

Provided are filter media and matrixes containing functional polymer particles, such as those formed from precipitation polymers, and methods of making and using the same. Functional polymer particles are useful because they eliminate the need to process other materials, such as naturally-occurring materials, to impart functionality, such as being charge-modified. Precipitation polymers are desirable due to their high purity and ease of processing. Filter media including functional polymer particles, such as precipitation polymers, are useful in making, for example, highly charged depth filter media and monolithic chromatography articles. Aspects include the use of synthetic material and/or some natural materials to make a filtration media using one or more precipitation polymers as one of the materials of composition. Such media are intended to provide high capacity, high throughput, and low levels of impurities.

Using functional polymer particles can reduce or eliminate the need to use a charge/binding modifying resin and its attendant cross-linker. In addition, the amount of adsorbers mined from the earth or created from natural material used in filter media can be reduced. Furthermore, by using micron-sized polyethylene particles, cellulose can also be eliminated from the filtration matrix. In one or more embodiments, an all-synthetic depth filter matrix can include low molecular weight polyethylene, high molecular weight polyethylene, very high molecular weight polyethylene, ultra high molecular weight polyethylene, or combinations thereof. Providing all-synthetic filters can result in cleaner filters that should require fewer flush out volumes as compared to filters containing media components originating from naturally-occurring materials. Also, the precipitation polymers can be tailored to have a desired amount of charge or chosen functional group. This in turn, allows for better filtration efficiency by better making use of the entire structure and controlling the binding of desired and undesirable filtrates. In addition to depth filters, the precipitation polymer particles can be incorporated into plastics to add or increase the charge of membranes/other structures or to functionalize the membrane structure. Precipitation polymers can also be used in monolithic blocks for chromatography to remove, for example, negatively charged impurities such as DNA or HCP's from a clarified cell broth from a bioreactor.

Filters made from media containing precipitation polymers can be used as stand-alone filters or as pre-filters to protect downstream membrane filters or separation technology.

The term “functional polymer particle” includes particles formed from one or more polymers that have a function suitable to treat fluids such as water. Suitable functionalities relate to removing, reducing, and/or capturing contaminants from fluids. The particles may be, without limit, for example, cationic, anionic, hydrophilic, hydrophobic, selectively absorptive, and/or selectively adsorptive. In a “mixed mode,” a combination of ion exchange and hydrophobic interaction (HIC) functionalities can be used. Functional polymer particles may also serve as chelating agents for metal removal.

The term “precipitation polymer” (also referred to as “ppt polymer”) includes polymers formed in a precipitation polymerization. A polymerization reaction is one in which the polymer being formed is insoluble in its own monomer or in a particular monomer-solvent combination and thus precipitates out as it is formed. A precipitation polymer, as formed, can have functionalities that are suitable for treating water.

Suitable monomers, used singly or in combination, include essentially any free radically polymerizable monomer that is also capable of interacting with a target solute by hydrophobic, hydrophilic, hydrogen bonding, electrostatic or combination interactions thereof. Useful hydrophobically interactive monomers include acrylics such as methyl acrylate, methyl methacrylate, benzyl acrylate, butyl methacrylates, cyclohexyl methacrylate and dodecyl methacrylates. Useful hydrophilically interactive monomers include N,N-dimethylacrylamide, N-vinylpyrrolidinone, methoxyethoxyethyl acrylate, and mono-hydroxy polyethyleneglycol acylates and methacrylates. Useful monomers capable of hydrogen bonding interactions include methacrylamide, acrylamide, N-vinylformamide and 2-hydroxyethyl methacrylate. Electrostatically interactive monomers include:

1) positively charged strongly basic anion exchange monomers such as [3-(methacryloylamino)propyl]trimethylammonium chloride (MAPTAC) [3-(acryloylamino)propyl]trimethylammonium chloride (APTAC) and 4-vinylbenzyltrimethylphosphonium chloride;

2) positively charged weakly basic anion exchange monomers such as 3-(N-isopropylamino)propyl methacrylamide;

3) negatively charged strongly acidic cation exchange monomers such as sodium 4-vinylbenzenesulfonate and sodium 2-acrylamido-2-methylpropanesulfonate (AMPS, sodium salt); and

4) negatively charged weakly acidic cation exchange monomers such as tetramethylammonium acrylate.

MAPTAC and AMPS are two embodiments of the present disclosure. MAPTAC has a molecular weight of approximately about 220.5 g/mol (e.g., ranging from ˜220 to ˜221 g/mol). At a low enough molecular weight, homo-MAPTAC is water-soluble. As a result, in one or more embodiments, at least about 15 by weight of cross-linker is generally used in conjunction with MAPTAC

Suitable crosslinking monomers include monomers containing more than one free radically polymerizable group. Polyethylenically unsaturated monomers derived from acrylic and methacrylic acids useful in the invention include: trimethylolpropane trimethacrylate (TMPTMA), trimethylolpropane triacrylate, pentaerythritol tetraacrylate, 1,4-butane dimethacrylate, and ethyleneglycol dimethacrylate. Polyethylenically unsaturated amide monomers useful in the invention include methylenebis(acrylamide) (MBA) methylenebis(methacrylamide), and N,N′-dimethacryloyl-1,2-diaminoethane. TMPTMA and MBA are two embodiments of the present disclosure. TMPTMA has a molecular weight of approximately about 338.4 g/mol.

In one or more embodiments, the surface of the functional polymer particle, for example, the precipitation polymer, has grafted species attached thereto. The grafting of materials to the surface of the precipitation polymer often results in an alteration of the surface properties or reactivity of the precipitation polymer. The materials that are grafted to the surface of the precipitation polymer are typically monomers (i.e., grafting monomers). The grafting monomers usually have both (a) a free-radically polymerizable group and (b) at least one additional function group thereon. The free-radically polymerizable group is typically an ethylenically unsaturated group such as a (meth)acryloly group or a vinyl group. The free-radically polymerizable group typically can react with the surface of the precipitation polymer when exposed to an electron beam. That is, reaction of the free-radically polymerizable groups of the grafting monomers with the precipitation polymer in the presence of the gamma irradiation beam results in the formation of functionalized polymer particles. One or more grafting monomers may be grafted onto interstitial and outer surfaces of the precipitation polymer to tailor the surface properties to the resulting functionalized substrate.

Proportions of the interactive monomers and crosslinking monomers generally range from 5:95 to 85:15 ratio parts by weight, respectively. Generally, particle bed volumes (mL/g) and surface areas (m2/g) increase as the concentration of the crosslinking monomers increase. These factors become important in device construction and performance and are generally counterbalancing, i.e., lower particle bed volumes (higher particle densities) are useful in minimizing dust and handling whereas higher surface areas generally afford greater access to and concentrations of interactive groups by the target solute. These properties can be appropriately optimized through proper formulation.

The term AIBN refers to 2,2′-azobisisobutyronitrile, having a molecular weight of approximately about 192.3 g/mol, which is an exemplary initiator for the precipitation polymeric reaction.

As used herein, “filtration device” refers to a device that removes or separates one or more contaminants from a liquid, such as water, as the liquid passes through the device. Such devices generally comprise a filtration matrix and a housing. Reference to the term “depth filter” includes filters that have physical principles according to surface filters, i.e., the ability to separate materials of a certain physical property, such as size or charge, from a fluid, and may capture and hold materials with in its filtration matrix. Depth filters have filter media configured with a thickness, for example, between ⅛ to 0.3 inches (3 to 7.6 mm). The thickness of the depth filter media creates a three dimensional matrix having a tortuous path. Separation of, for example, dirt particles from a fluid is achieved by, for example, a combination of adsorption (particle binding due to electrostatic or other physio-chemical interactions) and mechanical sieving (particle entrapment by smaller sized pores). Reference to matrix thickness means the fluid path length, i.e., the shortest distance the fluid travels from the entrance of the matrix to its exit.

Reference to “naturally-occurring filter materials” includes those materials mined from the earth or created from natural material that are suitable for filtering fluids. Such materials include diatomaceous earth (i.e. an earth having friable dust like silica of diatomaceous origin), perlite, talc, silica gel, activated carbon, asbestos, molecular sieves, clay, Avicel (microcrystalline cellulose), chitin, chitosan, sericin, and the like. For the most part, these adsorber particles have diameters of less than 10 microns. Siliceous materials, such as diatomaceous earth or perlite, are commonly used. Furthermore, it is known that adsorptive particulate materials may be impregnated with other chemicals for providing or enhancing selective adsorption characteristics. Reference to a matrix being substantially free of naturally-occurring filter materials includes having no more than 5% by weight of such materials in the matrix.

The term “adsorptive media” includes materials (called adsorbents) having an ability to adsorb particles or other molecular species via different adsorptive mechanisms. These media can be in the form of, for example, spherical pellets, rods, fibers, molded particles, or monoliths with hydrodynamic diameter between about 0.01 to 10 mm. If such media is porous, this attribute results in a higher exposed surface area and higher adsorptive capacity. The adsorbents may have combination of micropore and macropore structure enabling rapid transport of the particles and low flow resistance. Reference to a “comparative filtration media” means a media that is formed without materials that are functional polymer particles according to this disclosure.

“Filtration matrix” refers to a filtration element composed of functional particles in combination with a binder or backbone to form a composite shape. The binder may be any material capable of causing adhesion of the functional particles together such that they may be formed into a composite shape. Preferably, the binder material is a thermoplastic polymeric material, such as ultra high molecular weight polyethylene (UHMW PE). Should it be desirable, the binder material can be treated with plasma as provided in U.S. Pat. Nos. 6,878,419 and 7,125,603, the disclosures of which are incorporated by reference herein. Further treatment of binder materials can include treatment with an antimicrobial agent. In one example, the antimicrobial agent is an organosilicon quaternary ammonium compound in the form of 3-trimethoxysilylpropyl dimethyloctadecyl ammonium chloride, available under the tradename AEM 5700 from Aegis of Midland, Mich. Reference to “comparative filtration matrix” means that the comparative filtration matrix that does not contain functional polymer particles as provided by this disclosure.

The term “UHMW PE” refers to ultra-high molecular weight polyethylene having molecular weight of, for example, at least 750,000 and is described in commonly-owned U.S. Pat. No. 7,112,280, to Hughes et al., incorporated herein by reference in its entirety.

The term “HMW PE” refers to high molecular weight polyethylene having a molecular weight of, for example, less than 750,000.

Reference to “convoluted” UHMW PE includes particles having a unique morphology, much like popcorn, in which the particle itself is perforated and has a higher surface area due to the irregularities and convolutions compared to a particle having a substantially spherical shape. Convoluted UHMW PE particles have, for example, tortuous and irregular surface ridges, valleys, holes, pits, and caverns. UHMW PE can comprise particles of various sizes, such as 35 μm and 110 μm. Using a larger particle size of convoluted UHMW PE can result in more open filter media.

Reference to “spherical” UHMW PE includes particles that are nominally spherically-shaped. Such particles can comprise particles of various sizes, such as 60 μm.

Detailed embodiments provide that the polymeric binder comprises ultra high molecular weight polyethylene. Other embodiments provide that the polymeric binder further comprises particles having a generally spherical, non-porous structure. In specific embodiments, the particles having the irregular, convoluted surface have an average particle size in the range of 10 to 120 (or 20-50, or even 30-40) microns. Other specific embodiments provide that the particles having the generally spherical, non-porous structure have an average particle size in the range of 10 to 100 (or 20-80, or even 30-65) microns. Reference to “small” convoluted particles includes particles generally having 30 micron mean and 0.25 g/cc density. Reference to “large” convoluted particles includes particles generally having 120 micron mean and 0.23 g/cc. Reference to “small” spherical particles includes particles generally having 60 micron mean and 0.45 g/cc.

Reference to the terms “fluid and/or liquid” means any fluid and/or liquid capable of being processed through composite carbon block filters, including, not limited to, potable water, non potable water, industrial liquids and/or fluids or any liquid and/or fluid capable of being processed through a filtration apparatus.

By the term “contaminant,” it is meant a substance or matter in the fluid that has a detrimental effect on the fluid or subsequent processing or use of the fluid.

By the term “separation,” it is meant the method by which contaminants are removed from a fluid by flowing the fluid through a porous structure.

The term “electrokinetic adsorption” includes processes that occur when particulates (called adsorbates) accumulate on the surface of a solid or very rarely a liquid (called adsorbent), through Coulombic force, or other electrostatic interaction thereby forming a molecular or atomic film.

Reference to “biomolecule” includes molecules such as, for example, biomacromolecules that are constituents or products of living cells and include, for example, proteins (including CHOP and HCP), carbohydrates, lipids, viruses, mycoplasma, cells, cell debris, endotoxins, and nucleic acids (e.g., DNA and RNA). Detection and quantification as well as isolation and purification of these materials have long been objectives of investigators. Detection and quantification are important diagnostically, for example, as indicators of various physiological conditions such as diseases. Isolation and purification of biomacromolecules are important for therapeutic purposes such as when administered to patients having a deficiency in the particular biomacromolecule or when utilized as a biocompatible carrier of some medicament, and in biomedical research. Biomacromolecules such as enzymes which are a special class of proteins capable of catalyzing chemical reactions are also useful industrially; enzymes have been isolated, purified, and then utilized for the production of sweeteners, antibiotics, and a variety of organic compounds such as ethanol, acetic acid, lysine, aspartic acid, and biologically useful products such as antibodies and steroids. Reference to “CHOP” means Chinese Hamster Ovary Proteins, which refers to cell debris from mammalian cultures. HCP refers to Host Cell Proteins, which generally are pertinent to bacterial cultures.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements.

### Examples

### Example 1

A precipitation polymer was prepared as follows to provide a polymer having a nominal cross-linker to functional monomer weight ratio of 30:70. Amounts of 9.9 grams of trimethylolpropane trimethacrylate (TMPTMA) as a cross-linker, 46.2 grams of a 50% solution in water of [3-(methacryloylamino)propyl]-trimethylammonium chloride (MAPTAC) as a functional monomer, and 267 mL of iso-propyl alcohol (IPA) were mixed in a 3 L split resin flask having a mechanical stirrer, a condenser, a nitrogen inlet, an addition funnel, a thermocouple, a heating mantle, and a temperature controller. The mixture was heated to 60° C. A nitrogen purge was used at a flow of about 1 lpm (liters per minute). Once the mixture reached 60° C., a first amount of 0.42 g of 2,2′-azobisisobutyronitrile (AIBN) was added to the flask along with a 5 mL rinse of IPA and the nitrogen flow was reduced to 0.2 lpm. As the reaction mixture thickened, an amount of approximately 500 mL of IPA was added to control viscosity over about one hour. Three hours after the first amount of AIBN was added, a second amount of 0.21 g of AIBN was added to the flask along with a 5 mL rinse of IPA. After three hours, the materials were cooled and filtered through a sintered glass funnel to obtain the polymer particles. In the funnel, the particles were washed one time with IPA and 3 times with acetone—each time using an amount of 500 mL. The particles were dried on a rotovap and then in a vacuum oven (about 30 inches Hg and 80° C.) overnight.

Metanil yellow is a dye possessing a negative charge and capable of spectrophotometric analysis to quantify performance. The negative charge on the dye is a good model, for example, for DNA and host cell protein target impurity solutes in the biopharma downstream. The metanil yellow (MY) dye capacity of this precipitation polymer was 62.5 mg/g according to the following test procedure, referred to as the 8 ppm MY test procedure. A 0.100 g sample of the TMPTMA/MAPTAC precipitation polymer was closed in a 47 mm housing atop a tared glass filter. One liter of 8 ppm pH 7 buffered metanil yellow dye (having an initial absorbance at 430 nm of 0.415) was recirculated via a peristaltic pump at 30 mL/min through the sample for one hour. The final absorbance reading of 0.088 was used to calculate the 62.5 mg/g capacity. A comparison charge-treated diatomaceous earth had a metanil yellow dye capacity of about 15 mg/g according to the 8 ppm MY test procedure. A 0.1260 g sample of treated diatomaceous earth was closed in a 47 mm housing atop a tared glass filter. One liter of 8 ppm pH 7 buffered metanil yellow dye (having an initial absorbance at 430 nm of 0.402) was recirculated via a peristaltic pump at 30 mL/min through the sample for one hour. The final absorbance reading of 0.307 was used to calculate the 15 mg/g capacity

### Example 2

Filter pads were made using the precipitation polymer made according to Example 1. The filter pads had the composition of 50% diatomaceous earth (DE), 26.7% ultra high molecular weight polyethylene (UHMW PE) having particles of convoluted shape and nominal 35 μm size (PMX1), 13.3% ultra high molecular weight polyethylene (UHMW PE) having particles of spherical shape (PMX2) and nominal 60 μm size, and 10% precipitation polymer (ppt polymer), in percentages by weight. A ratio of UHMW PE-convoluted to UHMW PE-spherical was 2. The compositions were molded at 160° C. for 45 minutes.

Two filter pads were tested at 60 ppm MY concentration through to ½ initial absorbance, 30 mL/min, pH 7, each resulting in a capacity of approximately 149 mg/g. A third filter pad was tested using 120 ppm MY concentration, resulting in a capacity of approximately 161 mg/g.

### Example 3

### Comparative Example

Comparative filter pads were made without the precipitation polymer. The filter pads had the compositions in weight percent shown in Table 1 using materials of diatomaceous earth (DE), ultra high molecular weight polyethylene (UHMW PE) having particles of convoluted shape and nominal 35 μm size (PMX1), ultra high molecular weight polyethylene (UHMW PE) having particles of spherical shape (PMX2) and nominal 60 μm size, and optionally an ultra high molecular weight polyethylene having particles of convoluted shape having particles of a nominal size of 23 μm (X143). The compositions were molded at 160° C. for 45 minutes. Average metanil yellow dye capacities for each composition are also shown. Testing was according to a 60 ppm MY test procedure of weighing each molded disk, sealing into a 47 mm housing, flowing 300 mL of pH 7 buffer at 30 mL/min, and then flowing 60 ppm of pH 7 buffered metanil yellow dye to an end point of ½ the initial spectrophotometric absorbance.

TABLE 1

| | | | | Ratio | | Average |
|---|---|---|---|---|---|---|
| | DE | PMX1 | PMX2 | PMX1/ | X143 | metanil yellow |
| | % | % | % | PMX2 | % | dye capacity |
| 3-A | 50 | 33.3 | 16.7 | 2 | 0 | 28 |
| 3-B | 50 | 26.7 | 13.3 | 2 | 10 | 25 |

### Example 4

All-synthetic filter pads were made using the precipitation polymer according to Example 1. The pads had the compositions in weight percent shown in Table 2 using materials of ultra high molecular weight polyethylene (UHMW PE) having particles of convoluted shape and nominal 35 μm size (PMX1), ultra high molecular weight polyethylene (UHMW PE) having particles of spherical shape and nominal 60 μm size (PMX2), high molecular weight polyethylene (HMW PE) (FA700), and the precipitation polymer (ppt polymer). The composition was molded at 160° C. for 45 minutes. Average metanil yellow dye capacity for the composition is also shown.

TABLE 2

| | | | Ratio | | Ppt % | Average |
|---|---|---|---|---|---|---|
| | PMX1 | PMX2 | PMX1/ | FA700 | polymer | metanil yellow |
| | % | % | PMX2 | % | (30:70) | dye capacity |
| 4-A | 41.7 | 8.3 | 5 | 30 | 20 | 172^{a} |
| 4-B | 41.7 | 8.3 | 5 | 25 | 25 | 267^{b} |
| 4-C | 33.3 | 16.7 | 2 | 20 | 30 | 278^{b} |
| 4-D | 33.3 | 6.7 | 5 | 30 | 30 | 307^{b} |
| 4-E | 0 | 0 | 0 | 60 | 40 | 369^{a} |

^{a}tested at 60 ppm MY flow through to ½ initial absorbance, 30 mL/min, pH 7
^{b}tested at 120 ppm MY flow through to ½ initial absorbance, 30 mL/min, pH 7

### Example 5

Precipitation polymers were made according to Example 1, with variations of providing different ratios of TMPTMA cross-linker to MAPTAC monomer. All-synthetic filter pads using these precipitation polymers and no DE were made by adding amounts of the ingredients in amounts corresponding to the percentages noted in Table 3 to a Waring household blender, mixing for 30 seconds, knocking down the ingredients with a spatula and again blending for 30 seconds. The resulting mixture was spooned into cavities of an aluminum mold, the excess was removed with the edge of a straight-edge and tapped against the counter-top for 20 seconds. The cavities were refilled, smoothed as before with the straight-edge and again tapped for 30 seconds. The fill, smooth, and tap steps were repeated a total of 3 times. The mold was then placed in a preheated 160° C. oven for 45 minutes, once the oven had recovered its temperature. The pads had a composition, in weight percent, of 45.8% ultra high molecular weight polyethylene (UHMW PE) having particles of convoluted shape and nominal 35 μm size (PMX1), 9.2% ultra high molecular weight polyethylene (UHMW PE) having particles of spherical shape and nominal 60 μm size (PMX2), 15% high molecular weight polyethylene (HMW PE), and 30% of the precipitation polymer (ppt polymer). The ratio of cross-linker to monomer was changed among the samples as shown in Table 3. The compositions were molded at 160° C. for 45 minutes. Average metanil yellow dye capacity and BET surface area for the compositions are also shown. Metanil yellow testing was done as discussed above with a 120 ppm of pH 7 buffered metanil yellow dye.

TABLE 3

| | | Average | |
|---|---|---|---|
| | Ppt polymer Ratio | metanil yellow | BET Surface |
| | Crosslinker:Monomer | dye capacity | area, m²/g |
| 5-A | 30:70 | 330 | 20 |
| 5-B | 40:60 | 280 | 45 |
| 5-C | 50:50 | 245 | 110 |
| 5-D | 60:40 | 200 | 150 |
| 5-E | 70:30 | 110 | 225 |

### Example 6

### Comparative Example

A comparative filter pad that was a two layer graded density was tested for metanil yellow dye capacity using 60 ppm MY concentration. The average metanil yellow dye capacity was about 6.3.

### Example 7

### Testing

The filter pads of Examples 2 and 3 were tested with molasses as a contaminant to determine throughput and contaminant removal efficiency as demonstrated by 0.2 μm membrane protection. Testing was performed using 3 g/L of molasses at a flow rate of 15 mL/min through 47 mm disks. The testing system included a depth filter preceding the membrane which was in a separate housing. Membrane end pressure was taken when the system reached 25 psid.

TABLE 4

| | | Throughput up to 2 | |
|---|---|---|---|
| | Total System | psi rise in membrane | Membrane end |
| | Throughput, mL | pressure, mL | pressure, psid |
| 2 | 1580 | 1560 | 6 |
| 3-A | 1668 | 1157 | 24 |
| 3-B | 535 | 247 | 25 |

The filter pads of Example 2 having the precipitation polymer show improved ability to keep pressure drop across the membrane lower than the filter pads of Example 3 without the precipitation polymer. Overall, the filter pads of Example 2 provided more throughput up to 2 psi rise in membrane pressure as compared to the filter pads of Example 3.

The filter pads of Examples 5 and 6 were tested with molasses as described above.

TABLE 5

| | | Throughput up to 2 | |
|---|---|---|---|
| | Total System | psi rise in membrane | Membrane end |
| | Throughput, mL | pressure, mL | pressure, psid |
| 5-A | 727 | 727 | 1.8 |
| 5-B | 3045 | 3045 | 1.85 |
| 5-C | 3038 | 1235 | 10.9 |
| 5-D | 2421 | 813 | 16.5 |
| 5-E | 2664 | 1498 | 17.3 |
| 6 | 1547 | 1547 | 1.5 |
| Unprotected | 70 | 29.5 | 24 |
| 0.2 μm PES | | | |
| membrane | | | |

### Example 8A

A polymeric membrane was prepared using the precipitation polymer according to Example 1. The composition, in weight percent of the materials forming the membrane, was 0.7% precipitation polymer, 69.0% polyethylene glycol (PEG400), 13.8% polyethersulfone (PES), and 16.5% N-Methylpyrrolidone also known as 1-Methyl-2-pyrrolidinone (NMP). The membrane was prepared in way that is conventionally known to those skilled in the art.

The polymeric membrane formed had a metanil yellow dye capacity of about 26 mg/g according to the 8 ppm MY procedure referred to above. A weighed 47 mm disk of membrane made with the above composition was placed in a 47 mm housing. One liter of 8 ppm pH 7 buffered metanil yellow dye (having an initial absorbance at 430nm of 0.423) was recirculated via a peristaltic pump at 30 mL/min through the sample for one hour. The final absorbance reading of 0.299 was used to calculate the metanil yellow dye capacity of about 26 mg/g.

### Example 8B

A mixture of polymeric beads and fibers was prepared using the precipitation polymer according to Example 1. Using a composition, in weight percent, of 0.7% precipitation polymer, 69.0% polyethylene glycol (PEG400), 13.8% polyethersulfone (PES), and 16.5% N-Methylpyrrolidone also known as 1-Methyl-2-pyrrolidinone (NMP) materials, these beads were prepared by pumping the composition through a small diameter tubing into a household blender container having 8 oz water. While the blender was stirring there was an air gap between the high point of the water in the blender and the end of the small diameter tube of about 4 inches. When the composition fell into the water small fibers formed due to the rotation of the water in the blender then were chopped up by the blades of the blender into finer particulates. The fibers and particulates were formed due to quenching of the composition when it made contact with the water. In another trial, the blender was stopped and more water added to the blender which reduced the air gap between the top of the water and end of the tubing to about 2 inches it was noticed that the quenched composition formed droplet shaped particles with short tails, the blender blades were not spinning during this attempt. The capacity of these beads was 13.07 mg/g according to the 8 ppm of metanil yellow recirculated through the beads for 1 hour at 30 ml/min, by placing the beads in a 47 mm housing atop a tared glass filter.

### Example 8C

Long polymeric fibers were prepared using the precipitation polymer according to Example 1. Using the same composition as in Example 8B, long fibers were formed which appeared to have a lumen. These fibers were prepared by pumping the composition through a small diameter tubing into a household blender container having 8 oz quiesant water leaving an air gap of about 6 inches, while the composition was falling due to gravity from the end of the tube into the quench water the composition was sprayed with water using an atomizer as it fell into the water. Long fibers were formed that appeared to have a lumen.

### Example 9

### Comparative Example

A polymeric membrane was prepared without the precipitation polymer, having a composition in weight percent of a 69.5% polyethylene glycol (PEG400), 13.9% polyethersulfone (PES), and 16.6% N-Methylpyrrolidone also known as 1-Methyl-2-pyrrolidinone (NMP).

The comparison polymeric membrane had a metanil yellow dye capacity of about 2 mg/g and was testing according to the 8 ppm method provided above.

### Example 10

A precipitation polymer made according to Example 1 was added to a recipe for a conventional depth filter having naturally-occurring materials to form a modified depth filter. The modified depth filter had ingredients of 23% Kamloops (a bleached softwood Kraft pulp), 9% highly refined bleached softwood Kraft pulp, 58% diatomaceous earth, and 10% precipitation polymer. Metanil yellow dye capacity for this filter was 86.7 mg/g. Metanil yellow testing was done according to the 120 ppm procedure, in which 120 ppm Metanil yellow was run through the material at 30 ml/min to an end point of ½ the initial absorbance. In comparison, a conventional depth filter, without 10% precipitation polymer and having 68% diatomaceous earth instead, that uses the diatomaceous earth modified with a quaternary amine and a cross-linker, provides a charge capacity of 10.98 mg/g.

### Example 11

A formulation of 6.0 grams of 30:70 MAPTAC:TMPTMA [are we sure about this ratio?] precipitation polymer according to Example 1 was mixed with 12.33 grams of PMX1 & 1.67 grams of PMX2 backbone polymers. These powders were then blended in a Waring blender for one minute. An aluminum mold with three-52 mm diameter by 6 mm deep cavities was pretreated with a PTFE release spray to prevent sticking. The powder blend was then filled into the mold, using approximately 13 grams of the powder. During the filling operation, the mold was tapped for 30 seconds and the powder was compressed with a cylinder slightly smaller than the mold cavity to eliminate voids.

A cover was bolted on the mold assembly, and the assembly was placed in an oven set at 177° C. for one hour (measured from when the temperature recovered to the set point). The mold was removed from the oven and allowed to cool to room temperature. The resulting disks averaged 48.5 mm in diameter and 5.5 mm in thickness. The disks averaged 3.7 grams in weight.

The resulting disks were then subjected to two different challenges. First, a disk was put into a holder and flushed with high purity water (18.2 megohm-cm). Aliquots of this water were sampled and then subjected to total organic carbon (TOC) analysis to determine the level of flushing required to reduce the extractables level to below 0.5 ppm. In a first run, after flushing for about 10 minutes at 11 mL/min, the TOC was <0.5 ppm. In a second run, the TOC was <0.5 ppm after 15 minutes at the same flow rate.

After flushing, each disk was then challenged with a 1.02 mg/mL solution of BSA (Sigma Aldrich A3294-50G in a 10 mM solution of 3-[N-Morpholino] Propane Sulfonic Acid (MOPS) buffer at pH=8.0. This solution was fed at a flowrate of 13.1 mL/min, which was approximately two bed volumes/minute. The effluent was monitored using an Agilent 8453 UV/vis spectrophotometer equipped with a flow cell and a sipper system, monitoring for a peak at 280 nm. An exemplary disk allowed an amount of 144 mL of solution to pass through to 10% breakthrough, which equated to a dynamic binding capacity of 15.7 mg BSA/cm³.

### Example 12

A formulation of 6.0 grams of 50:50 MAPTAC:MBA (methylene bis-acrylamide) precipitation polymer was mixed with 11.75 grams of PMX1 & 2.25 grams of PMX2 backbone polymers. Disks were prepared as described in Example 11.

The disks had TOC results from flushing studies showing that extractables were below 1.0 ppm after the equivalent of flushing a 10″ cartridge with 10 liters of distilled water.

The disks were challenged with a 0.5 mg/ml BSA solution in 10 mM MOPS, pH=8.0 at a flowrate of 10-12 mL/min. BSA binding capacities of 8-15 mg BSA/cm³ were obtained.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A filtration matrix for the removal of contaminants comprising functional polymer particles and a polymeric binder.

2. The filtration matrix of claim 1, wherein the functional polymer particles comprise a cationic charge.

3. The filtration matrix of claim 1, wherein the functional polymer particles comprise an anionic charge.

4. The filtration matrix of claim 2, wherein the functional polymer particles comprise polymerized [3-(methacryloylamino)propyl]-trimethylammonium chloride (MAPTAC) and an amount of at least 15% by weight of the particles of a cross-linker.

5. The filtration matrix of claim 4 wherein the functional polymer particles comprise [3-(methacryloylamino)propyl]-trimethylammonium chloride (MAPTAC) polymerized with trimethylolpropane trimethacrylate (TMPTMA).

6. The filtration matrix of claim 5, wherein a ratio of trimethylolpropane trimethacrylate (TMPTMA) to [3-(methacryloylamino)propyl]-trimethylammonium chloride (MAPTAC) is in the range of 95:5 to 15:85.

7. The filtration matrix of claim 1, wherein the filtration matrix is effective to provide an increased charge capacity as compared to a comparative filtration matrix that does not contain any functional polymer particles.

8. The filtration matrix of claim 1 that is substantially free of naturally-occurring filter materials.

9. The filtration matrix of claim 8, wherein the functional polymer particles are present in an amount of at least 10% by weight of the matrix.

10. The filtration matrix of claim 1 further comprising up to 40% by weight of a naturally-occurring filter material.

11. The filtration matrix of claim 10, wherein the filtration matrix comprises up to about 5% by weight of the functional polymer and is effective to provide a charge capacity that is at least a factor of 3 times greater than the comparative filtration matrix.

12. The filtration matrix of claim 1, wherein the polymeric binder comprises polyethylene.

13. The filtration matrix of claim 12, wherein the polyethylene comprises ultra high molecular weight polyethylene.

14. The filtration matrix of claim 1, wherein the polymeric binder comprises particles having an irregular, convoluted surface.

15. A filtration matrix comprising a precipitation polymer of [3-(methacryloylamino)propyl]-trimethylammonium chloride (MAPTAC) polymerized with trimethylolpropane trimethacrylate (TMPTMA) and a polymeric binder comprising particles having an irregular, convoluted surface.

16. The filtration matrix of claim 15, wherein the particles having an irregular, convoluted surface are formed from ultra high molecular weight polyethylene.

17. The filtration matrix of claim 15, wherein a ratio of trimethylolpropane trimethacrylate (TMPTMA) to [3-(methacryloylamino)propyl]-trimethylammonium chloride (MAPTAC) is from 95:5 to 15:85.

18. The filtration matrix of claim 15, wherein the polymeric binder further comprises particles of substantially spherical shape.

19. The filtration matrix of claim 18, wherein a ratio of the particles having an irregular, convoluted surface to the particles of substantially spherical shape is in the range of 1:1 to 10:1.

20. The filtration matrix of claim 15 comprising the precipitation polymer in an amount in the range of 10 to 60% by weight and the polymeric binder in an amount in the range of 40 to 90% by weight.

21. A filtration system comprising a filter matrix formed from functional polymer particles and a polymeric binder, a housing surrounding the filter matrix, a fluid inlet, and a fluid outlet.

22. The filtration system of claim 21, wherein the functional polymer particles comprise [3-(methacryloylamino)propyl]-trimethylammonium chloride (MAPTAC) polymerized with trimethylolpropane trimethacrylate (TMPTMA).

23. The filtration system of claim 22, wherein the polymeric binder comprises ultra high molecular weight polyethylene particles having an irregular, convoluted surface.

24. The filtration system of claim 22, wherein the polymeric binder comprises a filter membrane formed from polyethylene glycol, and polyethersulfone.

25. A method of filtering comprising contacting a fluid with a filtration matrix comprising functional polymer particles and a polymeric binder.

26. The method of claim 25, wherein the filtration matrix has a thickness in the range of 3 to 100 mm.

27. The method of claim 25, further comprising locating the filtration matrix in a depth filtration system.

28. The method of claim 25, further comprising locating the filtration matrix in a chromatography system.

29. The method of claim 25, wherein the filtration matrix has an increased charge capacity as compared to a comparative filtration matrix that does not contain any functional polymer particles.

30. The method of claim 25, wherein the filtration matrix has a capacity of at least 35 mg/ml of a biomolecule at 10% breakthrough.

31. A method of making a filtration system comprising:
providing functional polymer particles;
contacting a polymeric binder with the functional polymer particles to form a media mixture;
heating the media mixture form a filtration matrix; and
inserting the filtration matrix in a housing to form the filtration system.

32. The method of claim 31 further comprising adding one or more naturally-occurring materials to the media mixture.

33. The method of claim 31, wherein the functional polymer particles are provided by preparing a precipitation polymer of [3-(methacryloylamino)propyl]-trimethylammonium chloride (MAPTAC) with at least 15% by weight of the particles of a cross-linker.

34. The method of claim 33 wherein the functional polymer particles are prepared from [3-(methacryloylamino)propyl]-trimethylammonium chloride (MAPTAC) polymerized with trimethylolpropane trimethacrylate (TMPTMA) in a ratio in the range of 95:5 to 15:85 of TMPTMA to MAPTAC.
